(19) United States
(12) Patent Application Publication
(10) Pub. No.: US 2023/0315869 A1
(43) Pub. Date: Oct. 5, 2023

(54) PRIVATE PRESENTATION OF SENSITIVE CONTENT

(71) Applicant: Microsoft Technology Licensing, LLC, Redmond, WA (US)

(72) Inventors: Eli REVACH, Rehovot (IL); Ishay Yosi MATATOV, Rehovot (IL)

(73) Assignee: Microsoft Technology Licensing, LLC, Redmond, WA (US)

(21) Appl. No.: 17/657,903

(22) Filed: Apr. 4, 2022

(51) Int. Cl. G06F 21/60

(52) U.S. Cl. CPC G06F 21/604; G06F 2221/2111

(57) ABSTRACT

Examples are disclosed that relate to safely accessing sensitive content in non-safe environments. One example provides a host computing device comprising an output device, a processor, and memory comprising instructions executable by the processor. The instructions are executable to receive a request to present a content item, access security information for the content item, and determine a current environment of the host computing device. The instructions are further executable to, when it is determined from the security information that the content item is a sensitive content item and that the current environment is not a safe environment for the content item, prevent presentation of the content item by the output device and send the content item to a private presentation device.

### BACKGROUND

Some digital content may include information that is intended only for authorized users. However, at times, an authorized user may open such digital content in a location in which unauthorized persons can view the content. For example, an employee may open confidential documents while in an airport or coffee shop.

Further, some content may be intended to be accessed by certain persons in an organization, to the exclusion of other persons. For example, a company that is developing new products may restrict access to information on the new products to a particular subset of employees, such as executives and a development team. In such scenarios, an authorized user may pose a risk of unauthorized access by opening the content in an unauthorized location on company premises.

### SUMMARY

Examples are disclosed that relate to accessing sensitive content in non-safe environments. One example provides a host computing device comprising an output device, a processor, and memory comprising instructions executable by the processor. The instructions are executable to receive a request to present a content item, access security information for the content item, and determine a current environment of the host computing device. The instructions are further executable to, when it is determined from the security information that the content item is a sensitive content item and that the current environment is not a safe environment for the content item, prevent presentation of the content item by the output device and send the content item to a private presentation device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A-1E illustrate an example scenario in which an authorized user is directed to present sensitive content using a private presentation device in a non-safe environment.

FIG. 2 shows a block diagram depicting an example system for presenting sensitive content in non-safe environments.

FIG. 3 schematically shows example sensors for determining a current environment for a host computing device.

FIG. 4 schematically shows an example user interface that may be displayed when presentation of sensitive content is requested in a non-safe environment.

FIGS. 5A and 5B show a flow diagram depicting an example method for presenting sensitive content.

FIG. 6 shows a block diagram of an example computing system.

### DETAILED DESCRIPTION

Some digital content that includes sensitive information may utilize security protocols, such as a password, to allow access only to authorized users. However, an authorized user may open such content in a location where the content may be perceived by people other than the authorized user. For example, the authorized user may be sitting next to other passengers on a train or airplane. As another example, the content may be opened on a display that is visible to an unauthorized camera. As a further example, content opened by an employee with authorization to access the content may be viewed by an employee in a nearby cubicle who is not authorized to access the content.

One possible solution to this issue is to use a privacy screen over the display. However, the privacy screen merely reduces an angle of view of the display. As such, an unauthorized viewer located behind the authorized user may be able to see the content open on the display.

Accordingly, examples are disclosed that relate to utilizing a private presentation device to present a sensitive content item in environments that pose a risk of unauthorized access. Briefly, a user may request a host computing device, such as a laptop computer, to present a content item. The host computing device accesses security information for the content item to determine whether the content item is sensitive. For a sensitive content item, the security information further may indicate one or more policies regarding safe environments for presenting the content item. The host computing device may determine a current environment of the host computing device, and compare the current environment to the security information. When the host computing device determines that the content item is a sensitive content item and that the current environment is not a safe environment for the content item, then the host computing device prevents presentation of the content item by an output device of the host computing device. The host computing device further provides the content to a private presentation device for presentation. On the other hand, when the host computing device determines that the current environment is a safe environment for the content item, the computing device may present the content item via the output device(s) of the host computing device. In this manner, the risk of an unauthorized person perceiving the presentation of sensitive content may be lessened relative to presenting the sensitive content on the host computing device.

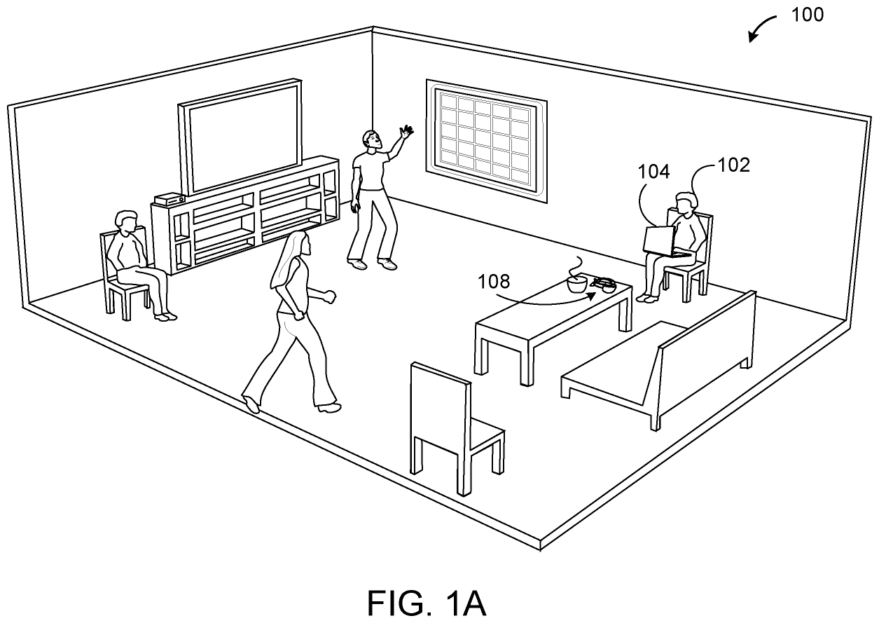

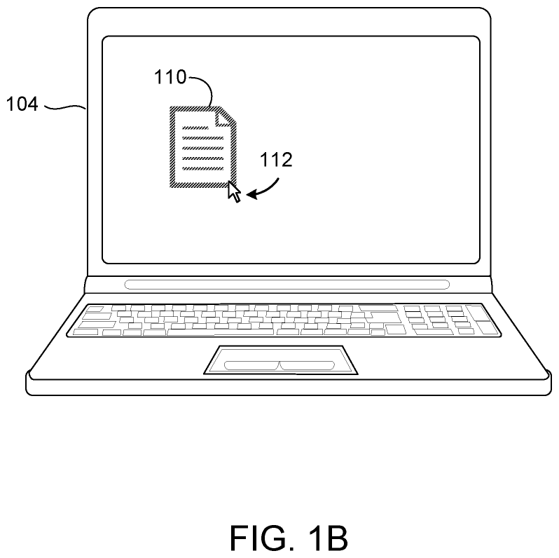

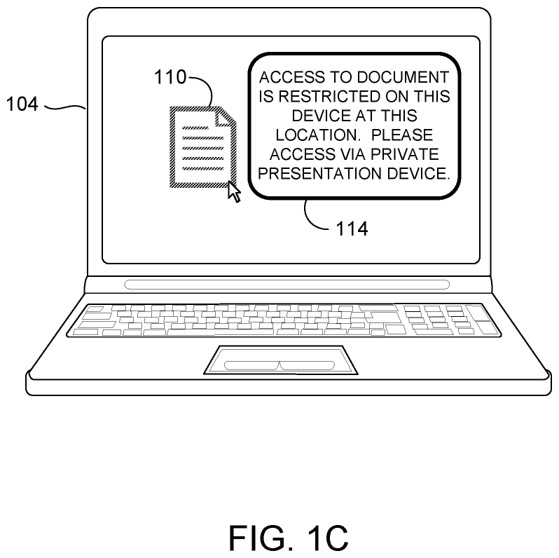

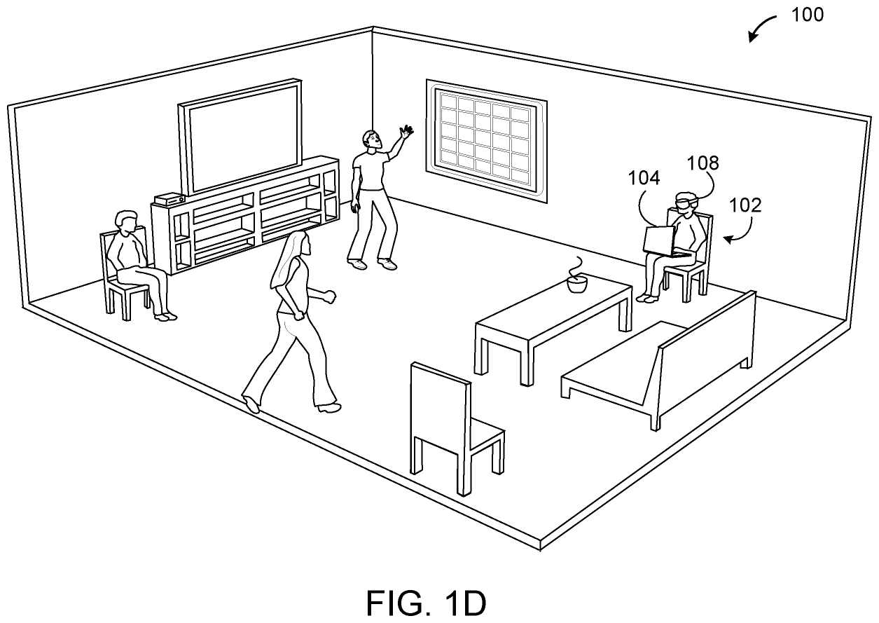

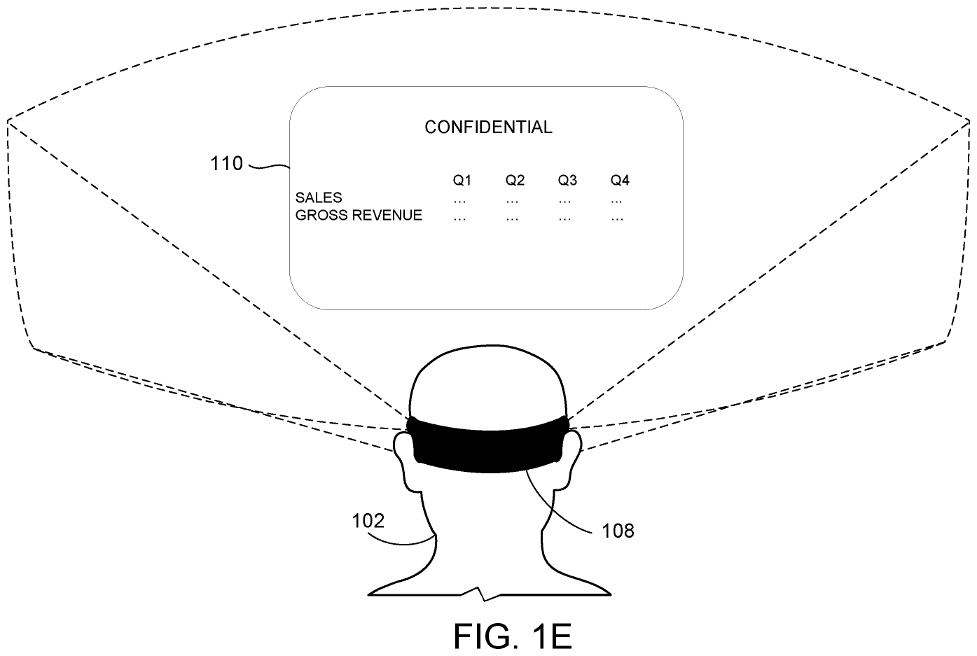

FIGS. 1A to 1E depict an example scenario in which sensitive content is accessed in a public area 100. In FIG. 1A, a user 102 in public area 100 is working on a laptop computer 104. Laptop computer 104 comprises a content security agent, described in more detail below, configured to monitor content accessed by user 102 to determine whether any content to be presented on laptop computer 104 is sensitive. User 102 also has access to a private presentation device, here depicted as a head-mounted display (HMD) device 108.

User 102 requests to open a content item 110 on laptop computer 104, as illustrated at 112 in FIG. 1B. The content security agent receives the request to open content item 110. In response, the content security agent accesses security information for content item 110, and determines a current environment of laptop computer 104, as will be discussed in more detail below. The security information for content item 110 indicates whether content item 110 is sensitive. Further, for sensitive content items, the security information may comprise one or more policies that indicate safe and non-safe environments for presenting content item 110. When the content security agent determines from the security information that the content item 110 is a sensitive content item and that the current environment is not a safe environment for content item 110, then the content security agent prevents presentation of content item 110 by one or more output devices of laptop computer 104 (e.g., a screen and/or speakers), as illustrated in FIG. 1C. In this example, laptop computer 104 displays a notification 114 indicating that content item 110 is restricted from presentation on laptop computer 104 in public area 100. Notification 114 further instructs user 102 to access content item 110 via HMD device 108.

Laptop computer 104 further sends content item 110 to HMD device 108 in encrypted form for presentation. HMD device 108 communicates with an authentication service to obtain one or more of an authorization token or a decryption key, decrypts content item 110, and presents content item 110. In FIGS. 1D and 1E, user 102 is shown wearing HMD device 108 to access content item 110. In such a manner, an authorized user may be able to open sensitive content items in a public area, without a risk of unauthorized access. HMD device 108 is an example of a private presentation device. In other examples, any other suitable private presentation device may be used.

Public area 100 of FIGS. 1A through 1E is one example of a non-safe environment. As mentioned above, any environment in which a sensitive content item may be viewed and/or heard by an unauthorized person (whether directly or by camera) may be defined as a non-safe environment via security information. Further, laptop computer 104 is one example of a host device. In other examples, a host device may comprise any other suitable computing device that may allow unauthorized persons to see and/or hear presentation of a sensitive content item. Examples may include desktop computers, tablet computers, and smart phones. In some examples, a smart phone or other small display device may be considered a private presentation device, such as where a host device comprises a less private device (e.g., a laptop computer).

Additionally, HMD device 108 is one example of a private presentation device. HMD device 108 may allow the presentation of both audio and video content privately, such that only user 102 can see and/or hear the presentation. In other examples, any other suitable type of device may be used as a private presentation device, such as audio-only devices (e.g., headphones or earbuds). Further, as mentioned above, in some examples, a smart phone or other type of device with a relatively smaller display screen may be considered a private presentation device in some contexts.

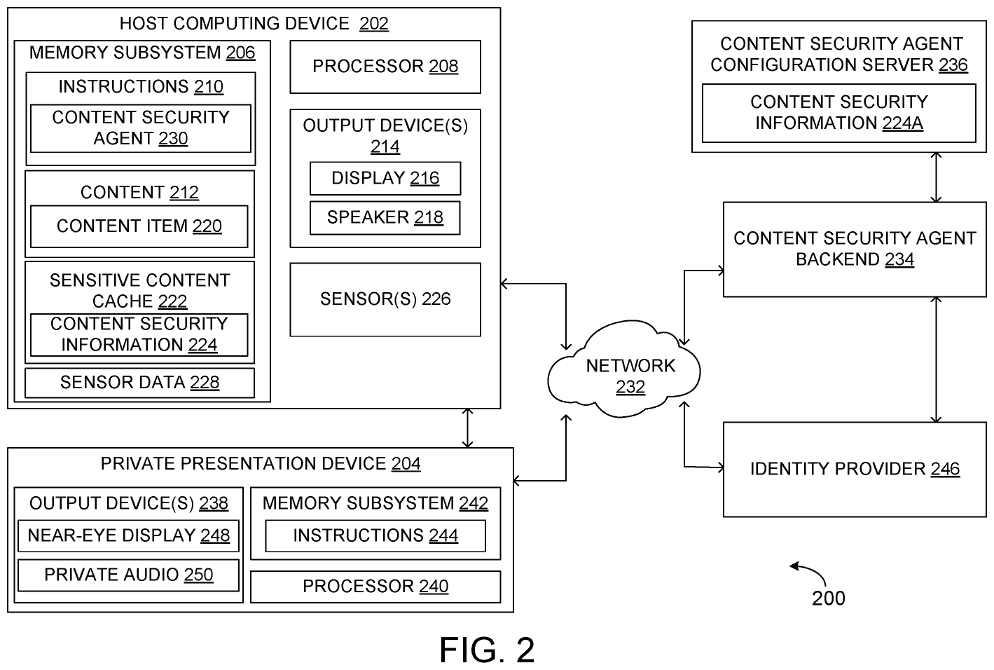

FIG. 2 shows an example system 200 for presenting sensitive content in non-safe environments. System 200 comprises a host computing device 202, and a private presentation device 204 in communication with host computing device 202. In some examples, host computing device 202 and private presentation device 204 communicate via a wireless connection, such as Bluetooth or other suitable wireless connection. In other examples, host computing device 202 and private presentation device 204 may communicate via a wired connection. Laptop computer 104 is an example of host computing device 202. Likewise, HMD device 108 is an example of private presentation device 204. In other examples, host computing device 202 and/or private presentation device 204 each may take any other suitable form.

Host computing device 202 comprises a memory subsystem 206 comprising one or more memory devices, and a processor 208. Memory subsystem 206 comprises instructions 210 executable by processor 208 to perform various computing tasks. For example, instructions 210 are executable to access and present content 212 via one or more output devices 214. Example output devices include a display 216 and a speaker 218.

In the depicted example, content 212 is stored in memory subsystem 206 of host computing device 202. In other examples, content 212 may be located on a network-accessible remote computing device, such as on cloud-based computing system. Content 212 may comprise any suitable type(s) of visual and/or audio content. Example content includes document content, audio content, image content, spreadsheet content, presentation content, design content, and video content. Content 212 is depicted as including a content item 220. Content item 220 may be one of a plurality of content items stored in memory subsystem 206.

Memory subsystem 206 further comprises a local sensitive content cache 222. Local sensitive content cache 222 may store content security information 224 for at least some items of content 212. As described below, where local sensitive content cache 222 does not contain content security information for a content item, the content security information may be obtained from a remote server. Content security information 224 may comprise, for example, information relating to a security policy that defines safe environments and/or non-safe environments for content item 220.

Host computing device 202 further comprises one or more sensors 226. Sensor data 228 from sensor(s) 226 is stored in memory subsystem 206. As described in more detail below, sensor data 228 comprises data indicative of a current environment of host computing device 202. Sensor data 228 may be used to determine whether a current environment is a safe environment for presenting content item 220 if content item 220 is sensitive.

Instructions 210 stored on host computing device 202 further comprise instructions executable to implement a content security agent 230. Content security agent 230 is configured to monitor content items accessed by a user of host computing device 202 for presentation. In some examples, content security agent 230 can receive a request to present the content item via intercepting operating system calls and/or application calls. In some examples, the application calls can be made by an application local to host computing device 202. In other examples, the application calls can be made by a web application hosted at a remote server, and/or from an application at any other suitable location.

Upon receiving a request to present content item 220, content security agent 230 is configured to access security information for content item 220. For example, content security agent 230 may be configured to check local sensitive content cache 222 for the security information. In some examples, as mentioned above, content security information for content item 220 may not be stored in local sensitive content cache 222. Thus, upon the occurrence of a cache miss, content security agent 230 may be configured to retrieve the security information from a remote server. For example, in FIG. 2, host computing device 202 is in communication with a content security agent backend 234 via a network connection 232. Content security agent backend 234 may comprise a cloud-based computing service in some examples. The term “cloud-based” as used herein represents the delivery of computing services via a computing network such as the internet.

Content security agent backend 234 accesses a content security agent configuration server 236. Content security agent configuration server 236 comprises content security information 224A for content items that may be accessed by host computing device 202. For example, host computing device 202 and private presentation device 204 may be managed by an organization (e.g., a business, an educational institution, a government, or other organization), and content security agent configuration server 236 may store content security information for content of the organization. Thus, in the event of a cache miss in the local sensitive content cache 222, content security agent 230 may communicate with content security agent backend 234 to obtain content security information 224A.

Upon obtaining content security information 224A via content security agent backend 234, content security agent 230 can update content security information 224 in local sensitive content cache 222 with the content security information 224A obtained. Storing the obtained content security information in local sensitive content cache 222 may reduce a latency on a next check for the security information in local sensitive content cache 222.

Content security agent 230 may determine from content security information 224 (and/or content security information 224A) that content item 220 is a sensitive content item. Further, content security agent 230 may determine from content security information 224 a policy defining a safe environment for presenting content item 220. Content security agent 230 also may determine from sensor data 228 a current environment of host computing device 202. Then, based upon comparing the current environment to the content security information 224, content security agent 230 may determine that the current environment is a safe environment for content item 220. In this instance, content security agent 230 is configured to permit presentation of content item 220 via output device(s) 214.

On the other hand, when content security agent 230 determines from the comparison of the current environment to content security information 224 that the current environment is not a safe environment for presenting content item 220, content security agent 230 is configured to prevent presentation of content item by output device 214. Content security agent 230 is further configured to provide content item 220 to private presentation device 204 for presentation. Providing content item 220 to private presentation device 204 for presentation may help to reduce a risk of an unauthorized person perceiving a presentation of content item 220.

In some examples, content security agent 230 may control host computing device 202 to output a notification via output device(s) 214 informing a user to use private presentation device 204 to present content item 220. Alternatively or additionally, in some examples, content security agent 230 may modify rendering of a display of content item 220, for example, by partially or fully obscuring a displayed image of content item 220.

In some examples, content security agent 230 is configured to encrypt content item 220 before sending content item 220 to private presentation device 204. Any suitable encryption may be used, such as JSON web token (JWT) encryption and/or public/private key encryption. In such a manner, content item 220 may be securely sent to private presentation device 204.

Private presentation device 204 comprises one or more output devices 238, a processor 240, and a memory subsystem 242. Memory subsystem 242 comprises instructions 244 executable to perform the various functions described herein. Private presentation device 204 may take any suitable form that provides for a greater degree of privacy when presenting content item 220 than host computing device 202. Examples include HMD devices, audio-only devices, and computing devices with smaller, more private displays than host computing device 202.

Private presentation device 204 is configured to establish a connection to host computing device 202, and receive a request from host computing device 202 to present content item 220. In some examples, the request comprises content item 220. In other examples, content item 220 may be provided separately from the request, for example, after private presentation device 204 is authenticated. Content item 220 may be provided to private presentation device 204 directly by host computing device 202, or may be obtained from remote storage, e.g., via content security agent backend 234.

Private presentation device 204 is further configured to obtain one or more of an authorization token or a decryption key from an authentication service to decrypt content item 220 for presentation. In the depicted example, private presentation device 204 is configured to obtain the one or more of the authorization token or the decryption key from an identity provider 246 via network 232. In such an example, private presentation device 204 may identify itself via identity provider 246 and send to content security agent backend 234 a request for permission to present content item 220. Content security agent backend 234 validates the identity and permissions of private presentation device 204, and in response provides an authorization token (e.g., a JWT token), a decryption key, and/or other suitable decryption information to private presentation device 204. Private presentation device 204 is configured to decrypt content item 220 with the decryption information, and to present content item 220 via output device(s) 238. Example output devices include near-eye display 248 and private audio 250.

As mentioned above, content security information 224 and 224A may be set by an organization, such as a company, educational institution, or government institution, among other examples. In some examples, different content security policies may be defined for different content items, and/or for different types of content items. As a more specific example, highly secure content may have different policies than companywide content). Further, in some examples, a security policy can be role-based. As an example, a different safe environment may be defined for an executive presenting content item 220 than a contract employee presenting content item 220. Such configurations may help to manage safe environments and/or non-safe environments for different access levels of various types of sensitive content items.

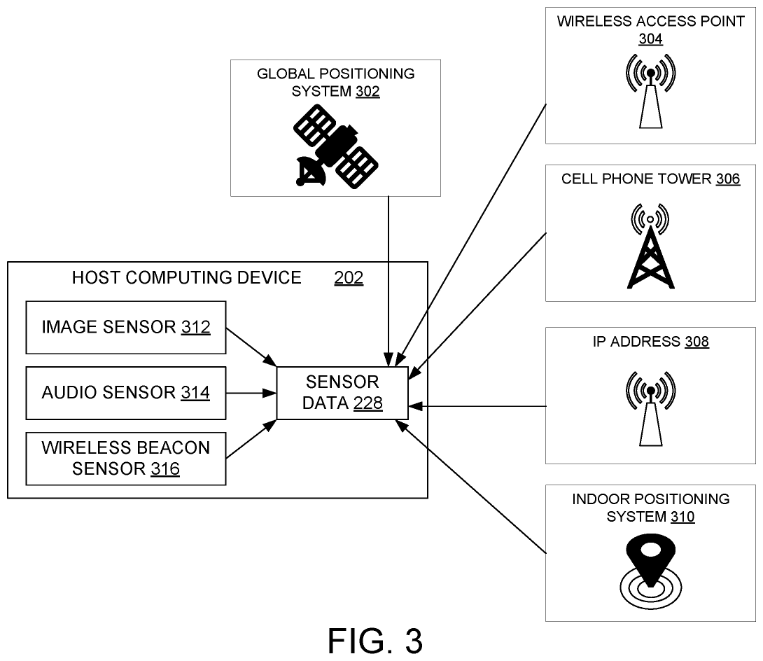

As previously mentioned, a host computing device may utilize various sensor data to determine a current environment of the host computing device. FIG. 3 schematically illustrates example sensors that may be used to determine a current environment of a host computing device. In some examples, a current environment for the purpose of content security may comprise a geographic location. As such, host computing device 202 may be configured to receive location data from one or more of a global position system (GPS) 302, a wireless access point 304, a cell phone tower 306, an internet protocol (IP) address 308 of a nearby wireless access point, and/or an indoor positioning system 310. The location data can comprise an absolute location and/or a relative location. In a more specific example, host computing device 202 can determine an outdoor location based on the location data from GPS 302, wireless access point 304, cell phone tower 306, and/or IP address 308. When the outdoor location is in a predefined radius of one of the safe environments, host computing device 202 can determine an indoor location by communicating with closest device of indoor positioning system 310. This may help to determine if a host computing device is within a designated safe environment within the premises of an organization, such as in a private office or secure lab as opposed to an open cubicle environment.

In some examples, host computing device 202 further may be configured to determine a current environment based at least in part on sensor data other than location data. For example, host computing device 202 may be configured use data from one or more of an image sensor 312, an audio sensor 314, and/or a wireless beacon sensor 316 (e.g. a Wi-Fi or Bluetooth radio) to sense a possible heightened risk of unauthorized access to sensitive content. Data from audio sensor 314 may be used to detect nearby voices, and/or an overall noise level. This may help to determine whether other people are close to host computing device 202. In other examples, audio sensor 314 may comprise a directional microphone configured to detect a presence of a person in a specific direction. In yet other examples.

Wireless beacon sensor 316 may be used to detect, for example, a Bluetooth beacon or other wireless beacon indicating a presence of a nearby device, such as within a specified distance Data from image sensor 312 may be used to detect human shapes within the field of view of the image sensor. Further, in some examples, image sensor 312 can be configured detect an unauthorized camera in image data. For example, image data from image sensor 312 may be classified using a trained machine learning classifier to identify various types of cameras, such as ceiling security cameras, smart phone cameras, laptop cameras, tablet cameras and/or handheld cameras. As a more specific example, a suitable neural network classifier, such as a convolutional neural network, may be trained using images of various types of cameras, in various settings and/or lighting, and from various perspectives. Similar training may be used to train a neural network classifier to recognize human shapes. Any suitable training algorithms may be used to train such a network, including stochastic gradient descent and backpropagation of error. In other examples, host computing device 202 alternatively or additionally may comprise any suitable sensor to detect a non-safe environment in any other suitable manner.

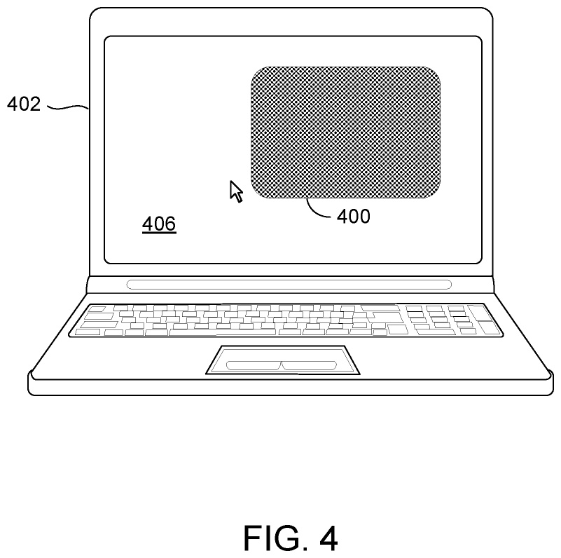

As previously mentioned, presentation of a sensitive content item is prevented on a host computing device when in a non-safe environment. In such an example, for visual content, any suitable substitute image may be presented. One such example is described above with regard to FIG. 1C. FIG. 4 shows another example user interface 400 that can be displayed when presentation of a sensitive content is prevented in a non-safe environment. Similar to host computing device 202, computing device 402 comprises a content security agent and an output device comprising a display 406. The content security agent has determined that a requested content item is a sensitive content item and that a current environment of computing device 402 is not a safe environment for presentation of the content item. As such, the content security agent prevents presentation of the content item by display 406. Instead, the content security agent controls computing device 402 to output a checkered pattern in user interface 400, instead of displaying the sensitive content. In other examples, user interface 400 can comprise a blank window, a window of a solid color, or any other suitable pattern.

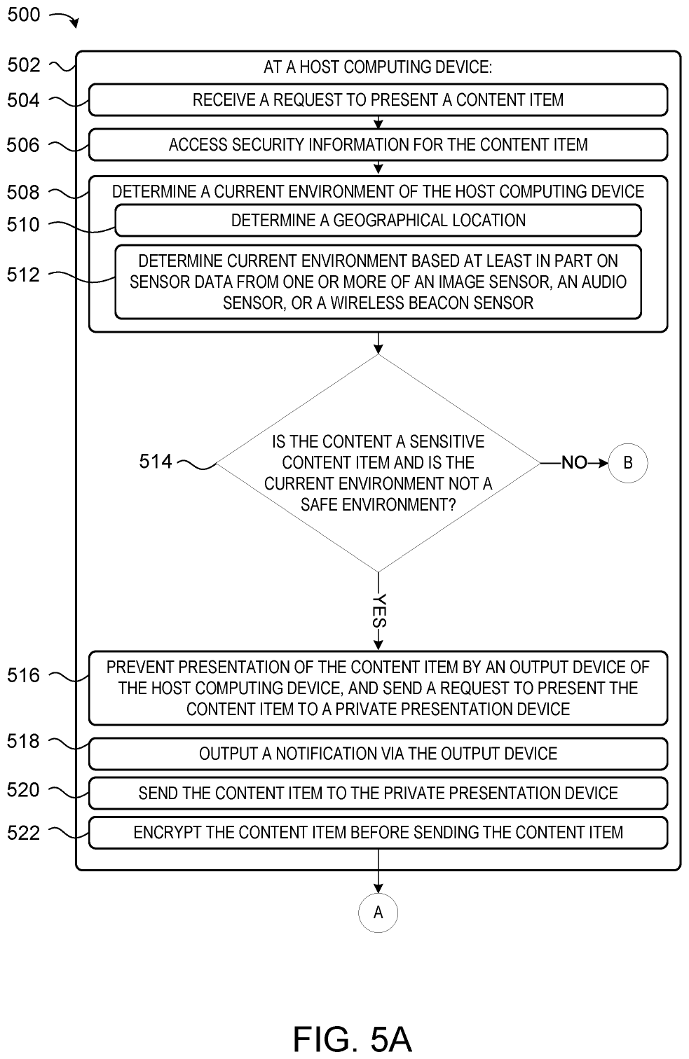

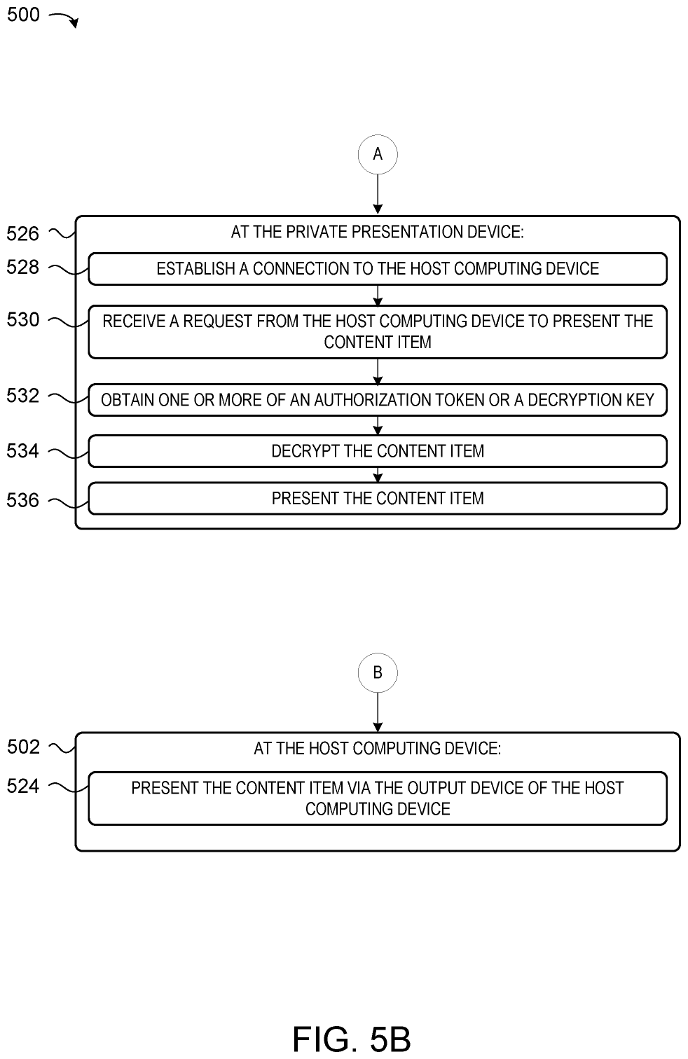

FIGS. 5A-5B depicts a flow diagram of an example method 500 for presenting sensitive content. Method 500 may be performed on a host computing device and a private presentation device. Laptop computer 104, host computing device 202, and computing device 402 are examples of host computing devices that may be used to enact portions of method 500. Likewise, HMD device 108 and private presentation device 204 are examples of private presentations devices that may be used to enact portions of method 500.

First referring to FIG. 5A, method 500 comprises, at 504, receiving a request to present a content item. The content item can comprise visual content and/or audio content. A content security agent on the host computing device may intercept operating system calls and/or application calls to open the content item, and access security content for the item. As such, method 500 comprises, at 506, accessing security information for the content item. The security information comprises information indicating a sensitivity level of the content item and/or information indicating safe environments and/or non-safe environments for the content item. Method 500 further comprises at 508, determining a current environment of the host computing device. In some examples, determining the current environment comprises, at 510, determining a geographical location based at least in part on one or more of a global positioning system location, a relative location to a wireless access point, a relative location to a cell phone tower, an IP address, or data from an indoor positioning system. Further, in some examples, determining the current environment comprises, at 512, determining the current environment based at least in part on sensor data from one or more of an image sensor, an audio sensor, or a wireless beacon sensor. This may help to determine whether other people are close to host computing device.

Continuing, method 500 determines from the security information if the content item is a sensitive content item and if the current environment is not a safe environment for opening the content item, as indicated at 514. When it is determined that the content item is the sensitive content item and that the current environment is not the safe environment for opening the content item, method 500 comprises, at 516, preventing presentation of the content item by an output device of the host computing device and sending a request to present the content item to a private presentation device. In some examples, method 500 comprises, at 518, outputting a notification via the output device of the host computing device when it is determined that the current environment is not the safe environment for the content item. In some such examples, the notification may be displayed instead of the content item. Continuing, method 500 comprises, at 520, sending the content item to the private presentation device. In some examples, a request to present the content item may be provided separately from the content item. In some examples, as indicated at 522, method 500 may encrypt the content item before sending the content item to the private presentation device. On the other hand, when it is determined that the current environment is the safe environment for the content item, method 500 comprises, at 524 in FIG. 5B, presenting the content item via the output device of the host computing device.

Continuing at the private presentation device, method 500 comprises, at 528, establishing a connection to the host computing device. In some examples the connection may be wireless, such as via Bluetooth. Method 500 comprises, at 530, receiving a request from the host computing device to present the content item. In some examples, the request may comprise the content item. In other examples, the content item may be provided separately from the request, for example, after the private presentation device is authenticated. Continuing, method 500 comprises, at 532, obtaining one or more of an authorization token or a decryption key from an authentication service. Method 500 further comprises decrypting the content item via the one or more of the authorization token or the decryption key, at 534, and presenting the content item via an output device of the private presentation device at 536. In such a manner, a sensitive content item can be privately presented in a non-safe environment and thus may help to reduce a confidentiality breach.

The disclosed examples of utilizing a private presentation device for presenting a content item when not in a safe environment for the content item thus may help to reduce a confidentiality breach of sensitive content. In this manner, a content item that is a sensitive content item may be presented differently in a safe environment than in a non-safe environment.

In some embodiments, the methods and processes described herein may be tied to a computing system of one or more computing devices. In particular, such methods and processes may be implemented as a computer-application program or service, an application-programming interface (API), a library, and/or other computer-program product.

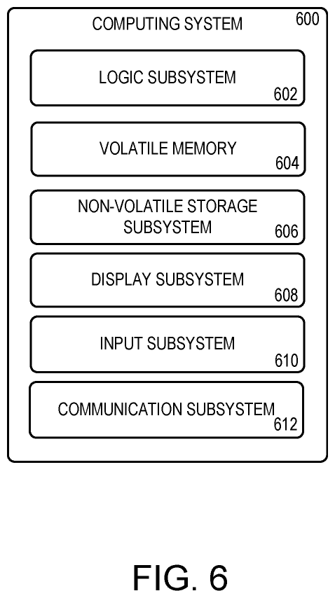

FIG. 6 schematically shows a non-limiting embodiment of a computing system 600 that can enact one or more of the methods and processes described above. Computing system 600 is shown in simplified form. Computing system 600 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices. Laptop computer 104, HMD device 108, host computing device 202, private presentation device 204, host computing device 202, private presentation device 204, and computing device 402 are examples of computing system 600.

Computing system 600 includes a logic subsystem 602 volatile memory 604, and a non-volatile storage subsystem 606. Computing system 600 may optionally include a display subsystem 608, input subsystem 610, communication subsystem 612, and/or other components not shown in FIG. 6.

Logic subsystem 602 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic subsystem 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage subsystem 606 includes one or more physical devices configured to hold instructions executable by the logic processors to implement the methods and processes described herein. When such methods and processes are implemented, the state of non-volatile storage subsystem 606 may be transformed—e.g., to hold different data.

Non-volatile storage subsystem 606 may include physical devices that are removable and/or built-in. Non-volatile storage subsystem 606 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage subsystem 606 may include nonvolatile, dynamic, static, read/write, read-only, sequential-access, location-addressable, file-addressable, and/or content-addressable devices. It will be appreciated that non-volatile storage subsystem 606 is configured to hold instructions even when power is cut to the non-volatile storage subsystem 606.

Volatile memory 604 may include physical devices that include random access memory. Volatile memory 604 is typically utilized by logic subsystem 602 to temporarily store information during processing of software instructions. It will be appreciated that volatile memory 604 typically does not continue to store instructions when power is cut to the volatile memory 604.

Aspects of logic subsystem 602, volatile memory 604, and non-volatile storage subsystem 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 608 may be used to present a visual representation of data held by non-volatile storage subsystem 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic subsystem 602, volatile memory 604, and/or non-volatile storage subsystem 606 in a shared enclosure, or such display devices may be peripheral display devices.

When included, input subsystem 610 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 600 to send and/or receive messages to and/or from other devices via a network such as the Internet.

Another example provides a host computing device, comprising an output device, a processor, and memory comprising instructions executable by the processor to receive a request to present a content item, access security information for the content item, determine a current environment of the host computing device, when it is determined from the security information that the content item is a sensitive content item and that the current environment is not a safe environment for the content item, prevent presentation of the content item by the output device and send the content item to a private presentation device. In some such examples, the instructions executable to access the security information alternatively or additionally comprise instructions executable to check a local sensitive document cache for the security information, and when the security information is not in the local sensitive document cache, retrieve the security information from a server. In some such examples, the instructions executable to determine the current environment alternatively or additionally comprise instructions executable to determine a geographical location based at least in part on one or more of a global positioning system location, a relative location to a wireless access point, a relative location to a cell phone tower, an internet protocol (IP) address, or data from an indoor positioning system. In some such examples, the instructions executable to determine the current environment alternatively or additionally comprise instructions executable to determine the current environment based at least on sensor data from one or more of an image sensor, an audio sensor, or a wireless beacon sensor. In some such examples, the instructions are alternatively or additionally executable to encrypt the content item before sending the content item to the private presentation device. In some such examples, the instructions are alternatively or additionally executable to, when it is determined that the current environment is the safe environment for the content item, present the content item via the output device. In some such examples, the instructions are alternatively or additionally executable to, when it is determined that the current environment is not the safe environment for the content item, output a notification via the output device.

Another example provides a private presentation device, comprising an output device, a processor, and memory comprising instructions executable by the processor to establish a connection to a host computing device, receive a request from the host computing device to present a content item, obtain one or more of an authorization token or a decryption key from an authentication service, decrypt the content item via the one or more of the authorization token or the decryption key, and present the content item via the output device. In some such examples, the instructions executable to establish the connection alternatively or additionally comprise instructions executable to establish a wireless connection. In some such examples, the instructions executable to receive the request to present the content item alternatively or additionally comprise instructions to receive the content item. In some such examples, the instructions executable to obtain the one or more of the authorization token or the decryption key from the authentication service alternatively or additionally comprise instructions executable to obtain the one or more of the authorization token or the decryption key from an identity provider. In some such examples, the private presentation device alternatively or additionally comprises a head-mounted display device. In some such examples, the output device alternatively or additionally comprises a private audio output device.

Another examples provides on a computing system comprising a host computing device, a method comprises receiving a request to present a content item, accessing security information for the content item, determining a current environment of the host computing device, and when it is determined from the security information that the content item is a sensitive content item and that the current environment is not a safe environment for opening the content item, preventing presentation of the content item by an output device of the host computing device and sending a request to present the content item to a private presentation device. In some such examples, determining the current environment alternatively or additionally comprises determining a geographical location based at least in part on one or more of a global positioning system location, a relative location to a wireless access point, a relative location to a cell phone tower, an internet protocol (IP) address, or data from an indoor positioning system. In some such examples, determining the current environment alternatively or additionally comprises determining the current environment based at least on sensor data from one or more of an image sensor, an audio sensor, or a wireless beacon sensor. In some such examples, sending the request to present the content item alternatively or additionally comprises sending the content item. In some such examples, the method alternatively or additionally comprises, encrypting the content item before sending the content item to the private presentation device. In some such examples, the method alternatively or additionally comprising, when it is determined that the current environment is the safe environment for the content item, present the content item via the output device of the host computing device. In some such examples, the method alternatively or additionally comprises, outputting a notification via the output device of the host computing device when it is determined that the current environment is not the safe environment for the content item.

Another example provides, on a computing system comprising a private presentation device, a method comprising establishing a connection to a host computing device, receiving a request from the host computing device to present a content item, obtaining one or more of an authorization token or a decryption key from an authentication service, decrypting the content item via the one or more of the authorization token or the decryption key, and presenting the content item via an output device of the private presentation device. In some such examples, establishing the connection alternatively or additionally comprises establishing a wireless connection. In some such examples, receiving the request to present the content item alternatively or additionally comprises receiving the content item. In some such examples, obtaining the one or more of the authorization token or the decryption key from the authentication service alternatively or additionally comprises obtaining the one or more of the authorization token or the decryption key from an identity provider.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A host computing device, comprising:
an output device;
a processor; and
memory comprising instructions executable by the processor to
receive a request to present a content item,
access security information for the content item,
determine a current environment of the host computing device,
when it is determined from the security information that the content item is a sensitive content item and that the current environment is not a safe environment for the content item, prevent presentation of the content item by the output device and send the content item to a private presentation device.

2. The device of claim 1, wherein the instructions executable to access the security information comprise instructions executable to check a local sensitive document cache for the security information, and when the security information is not in the local sensitive document cache, retrieve the security information from a server.

3. The device of claim 1, wherein the instructions executable to determine the current environment comprise instructions executable to determine a geographical location based at least in part on one or more of a global positioning system location, a relative location to a wireless access point, a relative location to a cell phone tower, an internet protocol (IP) address, or data from an indoor positioning system.

4. The device of claim 1, wherein the instructions executable to determine the current environment comprise instructions executable to determine the current environment based at least on sensor data from one or more of an image sensor, an audio sensor, or a wireless beacon sensor.

5. The device of claim 1, wherein the instructions are further executable to encrypt the content item before sending the content item to the private presentation device.

6. The device of claim 1, wherein the instructions are further executable to, when it is determined that the current environment is the safe environment for the content item, present the content item via the output device.

7. The device of claim 1, wherein the instructions are further executable to, when it is determined that the current environment is not the safe environment for the content item, output a notification via the output device.

8. A private presentation device, comprising:
an output device;
a processor; and
memory comprising instructions executable by the processor to
establish a connection to a host computing device,
receive a request from the host computing device to present a content item,
obtain one or more of an authorization token or a decryption key from an authentication service,
decrypt the content item via the one or more of the authorization token or the decryption key, and
present the content item via the output device.

9. The device of claim 8, wherein the instructions executable to establish the connection comprise instructions executable to establish a wireless connection.

10. The device of claim 8, wherein the instructions executable to receive the request to present the content item comprise instructions to receive the content item.

11. The device of claim 8, wherein the instructions executable to obtain the one or more of the authorization token or the decryption key from the authentication service comprise instructions executable to obtain the one or more of the authorization token or the decryption key from an identity provider.

12. The device of claim 8, wherein the private presentation device comprises a head-mounted display device.

13. The device of claim 8, wherein the output device comprises a private audio output device.

14. On a computing system comprising a host computing device, a method comprising:
receiving a request to present a content item;
accessing security information for the content item;
determining a current environment of the host computing device; and
when it is determined from the security information that the content item is a sensitive content item and that the current environment is not a safe environment for opening the content item, preventing presentation of the content item by an output device of the host computing device and sending a request to present the content item to a private presentation device.

15. The method of claim 14, wherein determining the current environment comprises determining a geographical location based at least in part on one or more of a global positioning system location, a relative location to a wireless access point, a relative location to a cell phone tower, an internet protocol (IP) address, or data from an indoor positioning system.

16. The method of claim 14, wherein determining the current environment comprises determining the current environment based at least on sensor data from one or more of an image sensor, an audio sensor, or a wireless beacon sensor.

17. The method of claim 14, wherein sending the request to present the content item comprises sending the content item.

18. The method of claim 17, further comprising, encrypting the content item before sending the content item to the private presentation device.

19. The method of claim 14, further comprising, when it is determined that the current environment is the safe environment for the content item, present the content item via the output device of the host computing device.

20. The method of claim 14, further comprising, outputting a notification via the output device of the host computing device when it is determined that the current environment is not the safe environment for the content item.

21. On a computing system comprising a private presentation device, a method comprising:
establishing a connection to a host computing device;
receiving a request from the host computing device to present a content item;
obtaining one or more of an authorization token or a decryption key from an authentication service;
decrypting the content item via the one or more of the authorization token or the decryption key; and
presenting the content item via an output device of the private presentation device.

22. The method of claim 21, wherein establishing the connection comprises establishing a wireless connection.

23. The method of claim 21, wherein receiving the request to present the content item comprises receiving the content item.

24. The method of claim 21, wherein obtaining the one or more of the authorization token or the decryption key from the authentication service comprises obtaining the one or more of the authorization token or the decryption key from an identity provider.
